(19) United States
(12) Patent Application Publication
(10) Pub. No.: US 2005/0165946 A1
(43) Pub. Date: Jul. 28, 2005

(54) Bi-directional wireless LAN channel access

(75) Inventor: Adrian P. Stephens, Cambridge (GB)

Correspondence Address: LeMoine Patent Services, PLLC;c/o PortfolioIP, P.O. Box 52050, Minneapolis, MN, 55402, US

(73) Assignee: Intel Corporation

(21) Appl. No.: 10/744,547

(22) Filed: Dec. 22, 2003

(51) Int. Cl. G06F 15/16

(52) U.S. Cl. 709/233

(57) ABSTRACT

Bi-directional communications using a single channel access in a wireless local area network reduces overhead associated with accessing the channel.

### FIELD

The present invention relates generally to computer networks, and more specifically to wireless networks.

### BACKGROUND

Access points and mobile stations that communicate in wireless networks may contend for access to a shared medium, or may be granted access to a shared medium. Each time a station accesses the shared medium, some overhead is incurred in the form of access requests, management information, control information, or the like. When a station accesses the shared medium to transmit a small amount of data, the overhead may be high. When a large number of such accesses are made, the overhead may increase.

### BRIEF DESCRIPTION OF THE DRAWINGS

FIG. 1 shows a diagram of a wireless network;

FIGS. 2 and 3 show bi-directional communications on a shared medium;

FIG. 4 shows a system diagram in accordance with various embodiments of the present invention; and

FIGS. 5 and 6 show flowcharts in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

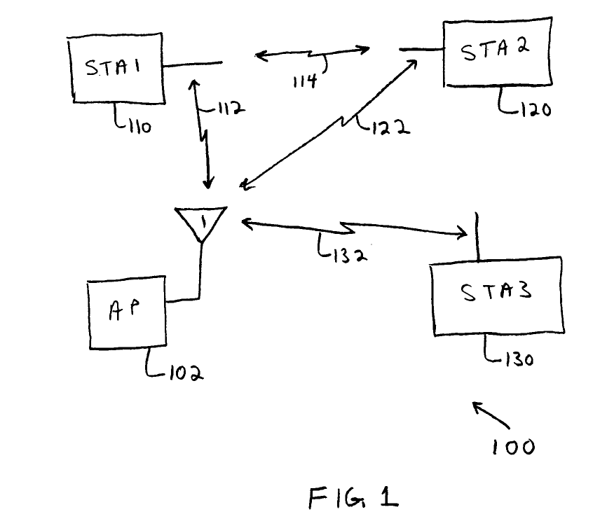

FIG. 1 shows a diagram of a wireless network. Wireless network 100 includes access point (AP) 102 and mobile stations (STA) 110, 120, and 130. In some embodiments, wireless network 100 is a wireless local area network (WLAN). For example, one or more of mobile stations 110, 120, and 130, or access point 102 may operate in compliance with a wireless network standard such as ANSI/IEEE Std. 802.11, 1999 Edition, although this is not a limitation of the present invention. As used herein, the term “802.11” refers to any past, present, or future IEEE 802.11 standard, or extension thereto, including, but not limited to, the 1999 edition. Mobile stations 110, 120, and 130 may be any type of mobile station capable of communicating in network 100. For example, the mobile stations may be computers, personal digital assistants, wireless-capable cellular phones, home audio or video appliances, or the like.

Access point 102 communicates with mobile station 110 (also referred to as “STA1”) using signal 112. Access point 102 communicates with mobile station 120 (also referred to as “STA2”) using signal 122, and access point 102 communicates with mobile station 130 (also referred to as “STA3”) using signal 132. In some embodiments, mobile stations communicate directly. For example, as shown in FIG. 1, mobile station 110 may communicate with mobile station 120 using signal 114. In some embodiments, signals 112, 122, and 132 are transmitted through a shared medium. For example, in some embodiments, the shared medium is the wireless channel in free space between the access point and the various mobile stations. Although AP 102 and mobile stations 110, 120, and 130 are shown communicating using a wireless shared medium in FIG. 1, this is not a limitation of the present invention. For example, in some embodiments, the shared medium may include one or more wires, and in other embodiments, the shared medium includes optical media. Further, in some embodiments, mobile stations may communicate with other mobile stations using the wireless shared medium.

In some embodiments, the various access points and mobile stations contend for the shared medium using a collision sense multiple access with collision avoidance (CSMA/CA) random access scheme. For example, a distributed coordination function (DCF) or enhanced distributed coordination function (EDCF) may be implemented in AP 102, and may also be implemented in mobile stations 110, 120, and 130 to provide a mechanism for the various elements shown in FIG. 1 to contend for the shared medium. In some embodiments, a DCF or EDCF may be implemented that is in compliance with an IEEE 802.11 standard, and in other embodiments, a DCF or EDCF may be implemented that is partially compliant with an IEEE 802.11 standard.

In some embodiments, the various access points and mobile stations use a contention-free access scheme to access the shared medium. For example, a point coordination function (PCF) or hybrid coordination function (HCF) may be implemented in AP 102 to provide for contention-free communications with one or more of mobile stations 110, 120, and 130. In some embodiments, a PCF or HCF may be implemented that is in compliance with an IEEE 802.11 standard, and in other embodiments, a PCF or HCF may be implemented that is partially compliant with an IEEE 802.11 standard.

In some embodiments, the various access points and mobile stations communicate using a hybrid coordination function (HCF) that provides quality of service (QoS) guarantees. In some embodiments, channel access schemes with QoS guarantees may be suitable for delay-sensitive or jitter-sensitive services, such as voice, video conferencing, or the like. These services may be characterized by constant or semi-constant intervals between subsequent packets, as well as low delay/jitter requirements.

In some embodiments, access point 102 may access the shared medium (also referred to as a “channel”), and transmit a burst of data followed by a response request. The channel access, the burst of data, or the response request may include a mechanism to reserve the channel to allow the mobile station to respond while the channel is reserved. In some embodiments, the mobile station may respond without having to contend for channel access in part because the access point has reserved the channel. Further, in some embodiments, the channel is reserved long enough for multiple responses between the access point and mobile station, providing for bi-directional communications with a single channel access. The channel access may be initiated by an access point, a mobile station or any other wireless-capable device; and the bidirectional communications may take place between an access point and a mobile station, two access points, two mobile stations, or any combination of wireless-capable devices.

Bi-directional communications with a single channel access may reduce overhead associated with channel access in a wireless network. For example, an IEEE 802.11 network experiencing a heavy transmission control protocol (TCP) traffic flow in one direction may experience a high rate of small packets in the other direction. Without bi-directional communications as described above, the channel may be used efficiently in the first direction, but the channel may be used inefficiently in the reverse direction, in part because many separate channel accesses may be performed to send the small packets in the reverse direction. Further, if a system blindly aggregates these small packets in an attempt to access the channel efficiently, it may unwittingly introduce unnecessary delay and limit throughput in the other direction due to the operation of the TCP protocol. In contrast, in some embodiments of the present invention, many small packets may be sent during a bi-directional exchange using a single channel access, thereby reducing the channel access overhead normally associated with small packets.

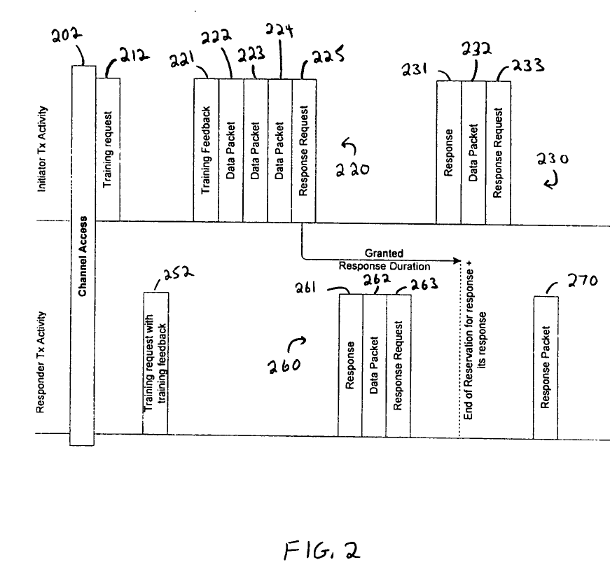

FIG. 2 shows bidirectional communications on a shared medium. The bi-directional communications are shown as transmit (Tx) activity on the part of an “initiator” and a “responder.” As used herein, the term “initiator” refers to an access point or mobile station that initiates the communication. In some embodiments, the initiator is the first to access the channel. Also as used herein, the term “responder” refers to an access point or mobile station that communicates with the initiator using bidirectional communications.

Channel access 202 is shown generically for both the initiator and the responder. In some embodiments, the initiator may be an access point that uses contention-free access to access the channel. In other embodiments, the initiator may be an access point that contends for the channel using a CSMA/CA mechanism. In still further embodiments, the initiator may be a mobile station that initiates the channel access. The channel access may be distributed (e.g., IEEE 802.11e DCF transmit opportunity “TXOP”) or centralized (e.g., IEEE 802.11e polled TXOP). The manner in which the channel is accessed is not a limitation of the present invention.

During bi-directional communications the channel may be reserved by the initiator or responder one or more times. As used herein, the term “reserve” refers to performing an action to prevent an unwanted transmission on the channel. For example, the channel may be reserved by maintaining control of the channel in a centralized manner, such as in PCF or HCF. The channel may also be reserved using a distributed mechanism such as setting a network allocation vector (NAV) in DCF. Further, a channel may be reserved by granting access to another station. For example, an access point may reserve the channel by granting access to a mobile station. After the mobile station accesses the channel, the access point may or may not regain control of the channel, or reserve the channel for a further period.

Either the initiator or responder may reserve the channel for use by either or both of the initiator and responder. For example, the initiator may already have the channel reserved when channel access 202 is commenced, (as in the case of some polled embodiments), and the initiator and responder may both transmit bursts during the time that the channel is reserved. Also for example, the initiator may reserve the channel as part of channel access 202 (as in the case of some distributed embodiments). The channel may be reserved for any amount of time, and one or both of the initiator and the responder may transmit during the time that the channel is reserved.

The channel may be reserved more than once during the bidirectional communications. For example, the initiator may reserve the channel long enough to access the channel and send training data. The responder may then reserve the channel for an additional amount of time. In some embodiments, the channel is reserved by the initiator for a period of time long enough to encompass both the current transmission by the initiator and a response transmission by the responder. Various embodiments including channel reservation are described further below.

As shown in FIG. 2, a sequence of frames follows channel access 202. The first frame 212 includes a training request that may be used by the responder to evaluate the channel and determine training feedback. After the responder evaluates the channel, it may transmit frame 252 including training feedback, which may allow more efficient transmission, including possibly transmitting at the highest possible rate, or transmitting at lower power for a given rate. Training feedback frame 252 may also allow the initiator to evaluate the channel.

The sequence shown in FIG. 2 corresponds to bidirectional “trained” (e.g., adapted to the channel) communications. In some embodiments, training is performed in both directions as shown in FIG. 2, and in some embodiments, training is performed in only one direction. Training is not a requirement. For example, in some embodiments, frames 212 and 252 are not sent, and “untrained” bidirectional communications takes place. All, some or none of the transmitted frames may be adapted to the channel using previous training feedback received.

In some embodiments, a sequence of bursts, each containing one or more frames, follows the channel access with the initiator and responder alternately transmitting. For example, as shown in FIG. 2, the initiator transmits bursts 220 and 230, and the responder transmits bursts 260 and 270. In some embodiments, bursts may include an optional response frame followed by zero or more frames that do not require an immediate response, optionally followed by a frame that requires an immediate response (response request). For example, burst 220 includes training feedback frame 221, data packet frames 222, 223, and 224, and response request frame 225. Frames 221-224 represent frames that do not require an immediate response, and frame 225 represents a frame that does require an immediate response. Burst 220 does not include a response frame. In some embodiments, response frames are included in a burst when an explicit or implicit response request was received in the previous burst.

In the example embodiments represented by FIG. 2, response request frame 225 reserves the channel for a period of time sufficient for the responder to transmit a burst. In some embodiments, the channel is reserved long enough for the responder to transmit a burst and the initiator to at least begin another burst. In this manner, the channel may continue to be reserved for the remainder of the bi-directional communications. In some embodiments, the response request or other frames in the burst may contain an implicit or explicit medium access grant. For example, the initiator may include a medium access grant in a response request that implicitly or explicitly grants medium access to the responder. Also for example, the responder may implicitly or explicitly grant access to the initiator.

Burst 260 is sent by the responder in response to burst 220. Burst 260 includes response frame 261, data packet frame 262, and response request frame 263. In some embodiments, response request frame 263 may reserve the channel for an additional amount of time. In embodiments represented by FIG. 2, response request frame 263 does not reserve the channel, in part because the initiator has reserved the channel for a period sufficient to encompass the transmission of burst 260.

Burst 230 is sent by the initiator in response to burst 260. Burst 230 includes response frame 231, data packet frame 232, and response request frame 233. The initiator and responder may continue to alternately transmit bursts in this manner until a burst is transmitted that does not require a response. For example, in the example embodiments of FIG. 2, the bi-directional communications stop after the responder transmits response packet 270. The bi-directional communications may stop with a transmission by either the initiator or the responder.

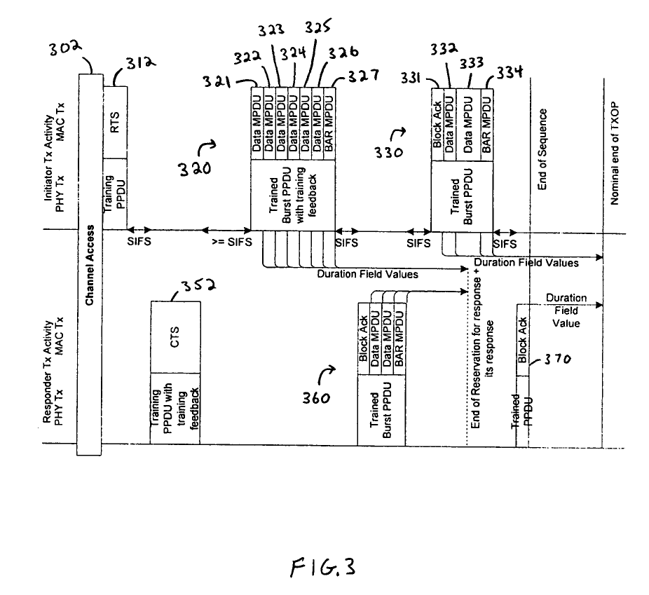

FIG. 3 shows bi-directional communications on a shared medium. In some embodiments, the bi-directional communications shown in FIG. 3 may be performed in compliance with, or in partial compliance with, an IEEE 802.11standard. The bi-directional communications is shown as transmit (Tx) activity on the part of an “initiator” and a “responder.” Further, transmit activity is split into medium access layer transmit activity (MAC Tx) and physical layer transmit activity (PHY Tx).

Channel access 302 marks the beginning of the bi-directional communications. The channel is accessed by the initiator sending a request-to-send (RTS) frame 312, and the responder sending a clear-to-send (CTS) frame. This channel access method corresponds to a distributed access such as DCF or EDCF. In other embodiments, the channel access method corresponds to a centralized access such as PCF or HCF. In embodiments represented by FIG. 3, the initial RTS/CTS exchange verifies that there is no collision and reserves the channel by setting up network allocation vector (NAV) reservation for some or all of the transmit opportunity (TXOP). The RTS/CTS exchange may also provide a mechanism for training. As shown in FIG. 3, the training request and training response (feedback) are carried in PHY headers, although this is not a limitation of the present invention. Training for the channel from the initiator to the responder may be provided in the physical layer convergence procedure (PLCP) protocol data units (PPDUs) corresponding to frame 312, and training for the channel from the responder to the initiator may be provided in training feedback carried in the first burst PPDU transmitted with frame 352.

In the context of IEEE 802.11, the burst may include an optional response MAC protocol data unit (MPDU) (e.g., acknowledgement “ACK” or BlockACK), followed by zero or more Data MPDUs sent under the IEEE 802.11 (e) BlockACK policy, followed by an optional MPDU requiring an immediate response (e.g. normal data, management, or a BlockACK request). In some embodiments, the Data MPDUs may be QoS Data MPDUs corresponding to an IEEE 802.11 standard with quality-of-service extensions, such as IEEE 802.11(e).

As shown in FIG. 3, the initiator transmits bursts 320 and 330, and the responder transmits burst 360 and frame 370. Burst 320 includes Data MPDUs 321-326, and BlockACK request (BAR) MPDU 327. In response to burst 320, the responder transmits burst 360 which includes a BlockACK, two Data MPDUs, and a BAR MPDU. In response to burst 360, the initiator transmits BlockACK 331, Data MPDUs 332 and 333, and BAR MPDU 334. Finally, in response to burst 330, the responder transmits BlockACK frame 370 to end the bi-directional communications started at channel access 302.

In some embodiments, the initiator may limit the duration of the responder bursts by setting a duration in its MPDU headers that is less than the remaining time in the TXOP. For example, the duration field values in the MPDU headers corresponding to burst 320 may be set to reserve the channel for a period sufficient to allow the responder to transmit a burst. Also for example, the duration field values may be set to reserve the channel for a period of time sufficient to allow the responder to transmit a burst plus the response burst to be transmitted by the initiator. In embodiments represented by FIG. 3, duration field values corresponding to burst 320 are set to allow a response by the responder as well as an additional response by the initiator. In some embodiments, the responder is required to honor this duration by ensuring that its response burst, plus any expected response MPDU fit entirely within the signaled duration.

The duration field values may also be set to correspond to the end of the transmit opportunity (TXOP). For example, the duration field values corresponding to burst 330 include duration field values that reserve the channel for the remainder of the TXOP.

The bursts are shown in FIG. 3 separated by a short interframe space (SIFS). In some embodiments, the period between transmitted bursts is shorter or longer than an SIFS. For example, in some embodiments, an interframe space longer than an SIFS is utilized between burst transmissions.

Any number of bursts may be sent in a single channel access. For example, the initiator and responder may alternately send bursts, and the process may be repeated any number of times. The communications end when an ACK or BlockACK is transmitted without Data MPDUs or an ACK request.

Various embodiments of the present invention allow multiple MPDUs to be aggregated in a burst transmission. For example, bursts 320, 360, and 330 each include multiple MPDUs. Aggregation of MPDUs and bi-directional communications on a single channel access may provide high throughput with reduced channel access overhead. For example, an IEEE 802.11 network experiencing a heavy TCP traffic flow in one direction may experience a high rate of small packets in the other direction. In some embodiments of the present invention, many small packets may be sent during a bidirectional exchange using a single channel access, thereby reducing the channel access overhead normally associated with small packets. Further, by aggregating many smaller transmissions into bursty bi-directional transmissions, channel training overhead may be shared among the bursts, and efficient trained communications may take place.

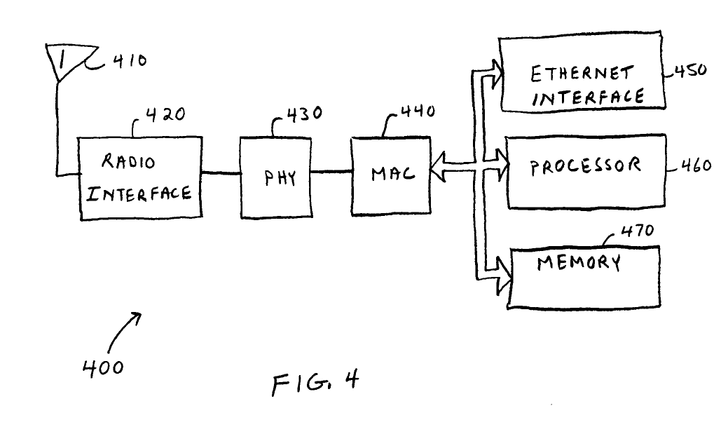

FIG. 4 shows a system diagram in accordance with various embodiments of the present invention. Electronic system 400 includes antenna 410, radio interface 420, physical layer (PHY) 430, media access control (MAC) mechanism 440, Ethernet interface 450, processor 460, and memory 470. In some embodiments, electronic system 400 may be an access point or mobile station capable of bi-directional communications using a single channel access. In some embodiments, electronic system 400 may be an access point or mobile station that can aggregate multiple MPDUs in burst transmissions. Further, in some embodiments, electronic system 400 may be an access point or mobile station that can reserve a shared medium or grant access to a shared medium for a period sufficient for one or more burst transmissions. For example, electronic system 400 may be utilized in network 100 as access point 102, or as one of mobile stations 110, 120, or 130. Also for example, electronic system 400 may be an access point or mobile station capable of communicating using bursts or frame sequences shown in the previous figures.

In some embodiments, electronic system 400 may represent a system that includes an access point or mobile station as well as other circuits. For example, in some embodiments, electronic system 400 may be a computer, such as a personal computer, a workstation, or the like, that includes a network interface as a peripheral or as an integrated unit. Further, electronic system 400 may include a series of access points that are coupled together in a network.

Antenna 410 may be a directional antenna or an omni-directional antenna. As used herein, the term omni-directional antenna refers to any antenna having a substantially uniform pattern in at least one plane. For example, in some embodiments, antenna 410 may be an omni-directional antenna such as a dipole antenna, or a quarter wave antenna. Also for example, in some embodiments, antenna 410 may be a directional antenna such as a parabolic dish antenna or a Yagi antenna. In still further embodiments, antenna 410 includes multiple physical antennas. For example, in some embodiments, multiple antennas are utilized to multiple-input-multiple-output (MIMO) processing or spatial-division multiple access (SDMA) processing.

In operation, system 400 sends and receives signals using antenna 410, and the signals are processed by the various elements shown in FIG. 4. Radio interface 420 is coupled to antenna 410 to interact with a wireless network. Radio interface 420 may include circuitry to support the transmission and reception of radio frequency (RF) signals. For example, in some embodiments, radio interface 420 includes an RF receiver to receive signals and perform “front end” processing such as low noise amplification (LNA), filtering, frequency conversion or the like. Also for example, in some embodiments, radio interface 420 may include circuits to support frequency up-conversion, and an RF transmitter. The invention is not limited by the contents or function of radio interface 420.

Physical layer (PHY) 430 may be any suitable physical layer implementation. For example, PHY 430 may be a circuit block that implements a physical layer that complies with an IEEE 802.11 standard or other standard. Examples include, but are not limited to, direct sequence spread spectrum (DSSS), frequency hopping spread spectrum (FHSS), and orthogonal frequency division multiplexing (OFDM).

Media access control (MAC) mechanism 440 may be any suitable media access control layer implementation. For example, MAC 440 may be implemented in software, or hardware or any combination thereof. In some embodiments, a portion of MAC 440 may be implemented in hardware, and a portion may be implemented in software that is executed by processor 460. Further, MAC 440 may include a processor separate from processor 460. MAC 440 may implement any of the bidirectional communications embodiments of the present invention. For example, MAC 440 may provide bursts of MPDUs for transmission on a shared medium.

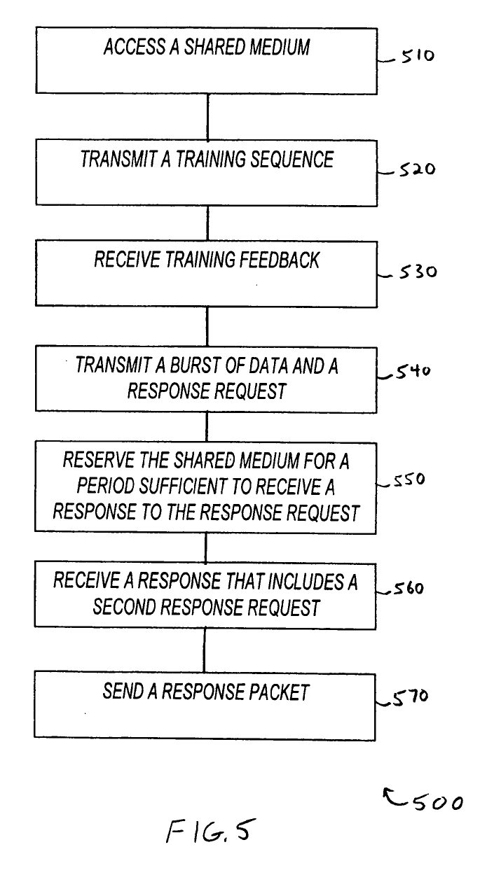

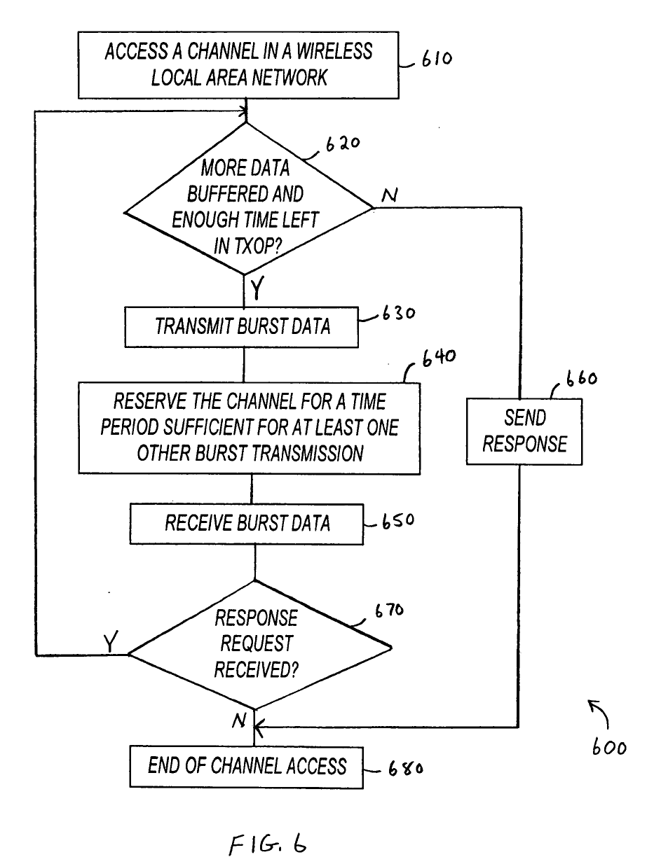

Processor 460 may perform method embodiments of the present invention, such as method 500 (FIG. 5) or method 600 (FIG. 6). Processor 460 represents any type of processor, including but not limited to, a microprocessor, a digital signal processor, a microcontroller, or the like.

Memory 470 represents an article that includes a machine readable medium. For example, memory 470 represents a random access memory (RAM), dynamic random access memory (DRAM), static random access memory (SRAM), read only memory (ROM), flash memory, or any other type of article that includes a medium readable by processor 460. Memory 470 may store instructions for performing the execution of the various method embodiments of the present invention.

Ethernet interface 450 may provide communications between electronic system 400 and other systems. For example, in some embodiments, electronic system 400 may be an access point that utilizes Ethernet interface 450 to communicate with a wired network or to communicate with other access points. Some embodiments of the present invention do not include Ethernet interface 450. For example, in some embodiments, electronic system 400 may be a network interface card (NIC) that communicates with a computer or network using a bus or other type of port.

FIG. 5 shows a flowchart in accordance with various embodiments of the present invention. In some embodiments, method 500 may be used to provide bi-directional communications using a single channel access in a wireless network. In some embodiments, method 500, or portions thereof, is performed by an access point, a mobile station, a processor, or an electronic system, embodiments of which are shown in the various figures. Method 500 is not limited by the particular type of apparatus, software element, or system performing the method. The various actions in method 500 may be performed in the order presented, or may be performed in a different order. Further, in some embodiments, some actions listed in FIG. 5 are omitted from method 500.

Method 500 is shown beginning at block 510 in which a shared medium is accessed. In some embodiments, the shared medium is accessed using a centralized mechanism such as polling, and in other embodiments the shared medium is accessed using a distributed mechanism such as CSMA/CA. When the shared medium is accessed, it may also be reserved for a period of time. For example, in some IEEE 802.11 embodiments, a RTS/CTS exchange may take place that sets a network allocation vector (NAV) in various stations as part of the actions in block 510.

At 520, a training sequence is transmitted. In some embodiments, the training sequence may be included in PHY headers as described above with reference to the various figures. At 530, training feedback is received. The training feedback may be received as part of a burst transmission, or may be received separately. For example, referring now back to FIGS. 2 and 3, the training sequence may be received at the beginning of a burst transmission, and the channel may be equalized using the training feedback received. In some embodiments, training is not employed. In other embodiments, training is employed in one direction of a bidirectional communications link. Further, in some embodiments, some, but not all, transmissions utilize training information.

At 540, a burst of data and a response request are transmitted. In some embodiments, the burst of data may include multiple aggregated Data MPDUs in compliance with, or in partial compliance with, an IEEE 802.11 standard. Further, the response request may be in the form of an ACK Request or BlockACK request in compliance with, or in partial compliance with, an IEEE 802.11 standard. At 550, the shared medium is reserved for a time period sufficient to receive a response to the response request. For example, duration field values may be set to grant access to another station. Example embodiments of reserving the shared medium are shown in FIGS. 2 and 3.

At 560, a response is received that includes a second response request. The received response may also include a burst of data. In some embodiments, the transmitted burst of data at 540 and the received response at 550 correspond to bi-directional burst communications using a single channel access in a wireless network.

At 570, a response packet is sent. In some embodiments, the response packet satisfies the second response request received at 560. Further, in some embodiments, the response packet includes ACK or BlockACK information to acknowledge receipt of the response received at 560. The response packet sent at 570 may end the bidirectional communications of method 500.

Although method 500 only explicitly describes transmitting once and receiving once, in some embodiments, bursts of data are alternately transmitted and received multiple times, and the shared medium is repeatedly reserved, during bi-directional communications using a single channel access.

FIG. 6 shows a flowchart in accordance with various embodiments of the present invention. In some embodiments, method 600 may be used to align a polling interval in a wireless network. In some embodiments, method 600, or portions thereof, is performed by a mobile station, a processor, or an electronic system, embodiments of which are shown in the various figures. Method 600 is not limited by the particular type of apparatus, software element, or system performing the method. The various actions in method 600 may be performed in the order presented, or may be performed in a different order. Further, in some embodiments, some actions listed in FIG. 6 are omitted from method 600.

Method 600 is shown beginning at block 610 in which a channel in a wireless local area network is accessed. For example, an IEEE 802.11 compliant access point or mobile station may access the channel. At 620, if more data is buffered to send, and sufficient time exists in the permitted channel access (TXOP), then burst data is transmitted at 630. If either no data is buffered or there is not enough time left, then a response is sent at 660. In some embodiments, the response sent at 660 corresponds to a response packet with no further response request. For example, the response request sent at 660 may correspond to frame 270 (FIG. 2) or frame 370 (FIG. 3).

At 630, burst data is transmitted, and at 640, the channel is reserved for a time period sufficient for at least one other burst transmission. In some embodiments, the burst data transmitted at 630 may include one or more response frames such as a BlockACK, one or more data frames, and a response request, such as a BlockACK request (BAR) frame. In some embodiments, reserving the channel may correspond to granting access to another station. The other station may limit the duration of its burst accordingly.

At 650, burst data is received. In some embodiments, the burst data received is in response to a response request sent at 630. The burst data received may include one or more response frames such as a BlockACK, one or more data frames, and a response request, such as a BlockACK request (BAR) frame. Alternatively, the burst data received may not include a response request. For example, the burst data received may include a single frame meant to end the bi-directional channel access.

At 670, if a response request was received, then method 600 checks whether more data is buffered and more time is available at 620. If a response request is not received, then the bi-directional channel access ends at 680. The loop that includes 620, 630, 640, 650, and 670 may be traversed as long as there is data buffered, time is available, and response requests are received. The combination of the various actions in method 600 provide a mechanism for bi-directional communications using a single channel access in a wireless local network.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

1. A method comprising:
accessing a shared medium;
transmitting a burst of data and a response request; and
reserving the shared medium for a time period sufficient to receive a response to the response request.

2. The method of claim 1 wherein reserving the shared medium comprises granting a station access to the shared medium.

3. The method of claim 1 wherein accessing the shared medium comprises polling a mobile station.

4. The method of claim 1 wherein accessing the shared medium comprises transmitting a request to send (RTS) frame and receiving a clear-to-send (CTS) frame.

5. The method of claim 1 wherein transmitting a response request comprises granting a response duration long enough to allow bidirectional communications.

6. The method of claim 1 further comprising receiving a response that includes at least one transmission control protocol (TCP) acknowledge packet.

7. The method of claim 1 further comprising receiving a response that includes a second response request.

8. The method of claim 7 further comprising transmitting a response packet.

9. The method of claim 7 further comprising transmitting a response that includes a third response request.

10. The method of claim 9 further comprising:
alternately sending and receiving bursts of data and response requests to form bidirectional communications on a single access of the shared medium; and
continuing to reserve the shared medium until the bidirectional communications is complete.

11. The method of claim 1 further comprising sending a training request prior to sending data.

12. The method of claim 11 further comprising receiving training feedback.

13. A method comprising:
accessing a channel in a wireless local area network;
transmitting a burst of data; and
reserving the channel for a time period sufficient for at least one other burst transmission.

14. The method of claim 13 wherein accessing the channel comprises transmitting an RTS frame.

15. The method of claim 13 wherein accessing the channel comprises transmitting a CTS frame.

16. The method of claim 13 wherein transmitting burst data comprises transmitting multiple IEEE 802.11 MAC protocol data units (MPDU).

17. The method of claim 16 wherein transmitting burst data further comprises transmitting an IEEE 802.11 block acknowledgement (BlockACK) request.

18. The method of claim 13 wherein accessing the channel comprises sending training data.

19. The method of claim 13 further comprising receiving transmission control protocol (TCP) acknowledge packets in a second burst, to provide bi-directional communications on a single channel access.

20. The method of claim 13 further comprising:
alternately sending and receiving burst traffic; and
continuing to reserve the channel as long as burst data is buffered to send.

21. The method of claim 13 wherein reserving comprises transmitting a network allocation vector value.

22. An apparatus including a medium adapted to hold machine-accessible instructions that when accessed result in a machine performing:
accessing a channel in wireless local area network;
transmitting burst data; and
reserving the channel for a time period sufficient for at least one other burst transmission.

23. The apparatus of claim 22 wherein accessing the channel comprises transmitting a request-to-send (RTS) frame and receiving a clear-to-send (CTS) frame.

24. The apparatus of claim 22 wherein accessing the channel comprises transmitting a CTS frame.

25. The apparatus of claim 22 wherein accessing the channel is performed in compliance with an IEEE 802.11 standard.

26. An electronic system comprising:
an antenna;
a radio interface coupled to the antenna;
a medium access control mechanism coupled to the radio interface to receive burst traffic having a granted response duration, and to transmit burst traffic during the granted response duration; and
an Ethernet interface coupled to the medium access control mechanism.

27. The electronic system of claim 26 wherein the medium access control mechanism operates in compliance with an IEEE 802.11 standard.

28. The electronic system of claim 26 wherein the medium access control mechanism is adapted reserve a shared medium, and alternately send and receive burst traffic while the shared medium is reserved.
